(19) United States
(12) Patent Application Publication
(10) Pub. No.: US 2022/0186355 A1
(43) Pub. Date: Jun. 16, 2022

(54) METHOD OF PRODUCING THERMAL SPRAY COATING USING THE YITTRIUM POWDER AND THE YITTRIUM COATING PRODUCED BY THE MOTHOD

(71) Applicant: KOMICO LTD., Anseong-si (KR)

(72) Inventors: Dae Sung Kim, Anseong-si (KR); Seong Sik Bang, Anseong-si (KR); Jae Im Jeong, Anseong-si (KR); Dong Hun Jeong, Anseong-si (KR)

(21) Appl. No.: 17/401,122

(22) Filed: Aug. 12, 2021

(30) Foreign Application Priority Data
Dec. 10, 2020 (KR) 10-2020-0172724

(51) Int. Cl. C23C 4/134; C23C 4/11; B05B 7/22

(52) U.S. Cl. CPC C23C 4/134; B05B 7/226; C23C 4/11

(57) ABSTRACT

Proposed is a method of producing an yttrium-based thermal spray coating. The method includes forming a coating on a substrate by atmospheric plasma spraying of an yttrium-based granular powder including at least one yttrium compound powder selected from the group consisting of Y₂O₃, YOF, YF₃, Y₄Al₂O₉, Y₃Al₅O₁₂, and YAlO₃, and a silica (SiO₂) powder. The yttrium-based granular powder includes less than 10 w % of a Y—Si—O mesophase. Then yttrium-based thermal spray coating can exhibit low porosity, high density, and excellent plasma resistance.

### CROSS-REFERENCE TO RELATED APPLICATION

The present application claims priority to Korean Patent Application No. 10-2020-0172724 filed on Dec. 10, 2020, the entire contents of which is incorporated herein for all purposes by this reference.

### BACKGROUND OF THE INVENTION

### Field of the Invention

The present disclosure relates to a method of producing a high-density thermal spray coating using an yttrium-based granular powder including a silica constituent.

### Description of the Related Art

In order to perform microfabrication for high circuit integration of a substrate such as a silicon wafer during the manufacture of a semiconductor, the importance of plasma dry etching is increasing day by day.

In view of such a circumstance, methods of using materials having excellent plasma resistance in a chamber member or forming a coating on the surface of the member with a material having excellent plasma resistance to extend the lifespan of the member have been proposed.

Of these, techniques to coat substrate surfaces with various materials to impart novel functionalities have been conventionally employed in various fields. One known example of such surface coating techniques is thermal spraying in which thermal spray particles made of a material such as ceramics are sprayed on the surface of a substrate in a semi-molten or molten state by means of combustion or electrical energy to form a thermal spray coating.

In general, the process of thermal spraying involves heating fine powders to a molten state, and spraying the molten powders toward a work surface of a substrate. As the sprayed molten powders are rapidly cooled down and solidified, they are deposited on and mechanically bonded to the work surface to form a coating.

Of thermal spraying techniques, plasma spraying that uses a high-temperature plasma flame to melt powders is essentially used in coating of metals and ceramics such as tungsten, molybdenum, etc., which have a high melting point. Thermal spraying improves the material characteristics of a substrate to produce a high-functional material that exhibits wear resistance, corrosion resistance, heat resistance and thermal barrier, super hardness, oxidation resistance, insulation, friction, heat dissipation, and biological function radiation resistance. Compared to other coating processes such as chemical vapor deposition, physical vapor deposition, etc., thermal spraying can provide coatings over a large area at high deposition rate.

Furthermore, in the field of fabrication of semiconductor devices, etc., in general, microfabrication is performed on the surface of a semiconductor substrate by dry etching using the plasma of a halogen-based gas such as fluorine, chlorine, bromine, etc.

After the dry etching process, a chamber (vacuum container) from which the semiconductor substrate has been taken out is cleaned with an oxygen gas plasma. In this case, there is a possibility that corrosion of members exposed to the highly reactive oxygen gas plasma or halogen gas plasma occurs inside the chamber. If corroded (eroded) portions peel off as particles from the members, these particles may adhere to the semiconductor substrate, becoming foreign substances that cause circuit defects (hereinafter referred to as “particles”).

Therefore, conventionally, in equipment for fabricating semiconductor devices, in order to reduce the generation of particles, members exposed to plasma of oxygen gas or halogen gas are provided with thermal spray ceramic coatings having plasma erosion resistance.

As a cause of such particles, in addition to peeling off of reaction products adhering in the chamber, a deterioration of the chamber due to the use of halogen gas plasma or oxygen gas plasma may be cited by way of example. In addition, according to the examination of the present inventors, it was found that the number and size of particles generated from a thermal spray coating under a dry etching environment are affected by the magnitude of the bonding force between powder particles constituting the thermal spray coating, the presence of unmelted powder particles, high porosity, etc.

In particular, as the density inside a thermal spray ceramic coating increases, the degree of adsorption of a CFx-based process gas caused by defects of pores, etc. during dry etching decreases, thereby reducing etching caused by plasma ion collision.

In general, as a coating technique for forming a high-density thermal spray coating, suspension plasma spraying (SPS), aerosol deposition (AD), or physical vapor deposition (PVD) is used. However, these three techniques all have the common disadvantages of a complicated manufacturing process and high manufacturing cost compared to conventional atmospheric plasma spraying (APS).

In the case of suspension plasma spraying (SPS), the use of a relatively high temperature heat source is accompanied by an increase in process temperature during coating in a semiconductor chamber, causing product deformation. Furthermore, as the size of powder particles decreases, the flight distance thereof becomes shorter. This also shortens the working distance between plasma equipment and a substrate, which allows limited working. Moreover, when a liquid suspension in which water and powder particles are dispersed is injected at the same volume, the deposition rate of the coating is lowered, which requires additional processing time, resulting in an increase in manufacturing cost.

Meanwhile, aerosol deposition (AD) and physical vapor deposition (PVD) are technically limited in achieving a coating thickness of several hundred μm, and are also limited in application to substrates of complex shape.

Therefore, there is a need for a technique capable of implementing a high-density thermal spray coating using conventional atmospheric plasma spraying (APS).

As a thermal spray material for conventional APS, granular powder with a medium grain size of 20 μm to 40 μm, which is composed of granular secondary particles formed by agglomeration of primary particles of several μm, is used. In view of this, a method of increasing the density of a thermal spray coating by configuring primary particles constituting a thermal spray material as small as equal to or less than 1 μm has been proposed. However, the increase in specific surface area of the thermal spray material hinders uniform heat transfer to the primary particles inside granular powder, with the result that a coating in an unmelted or re-melted state is formed on the surface or inside of the thermal spray coating and acts as a cause of particle generation during dry etching.

Furthermore, when the size of the secondary particles of the granular powder is too small, the secondary particles are agglomerated by the electrostatic attraction therebetween and thus difficult to transport in the atmosphere, or tend to fail to be transported to a central frame but to be scattered elsewhere due to low particle mass.

As a related art, Korean Patent Application Publication No. 10-2016-0131918 (2016 Nov. 16) discloses a thermal spray material including a rare earth element oxyhalide (RE-O—X) containing a rare earth element (RE), oxygen (O), and a halogen atom (X) as its elemental constituents. The rare earth element oxyhalide has a halogen to rare earth element molar ratio (X/RE) of equal to or greater than 1.1, thereby having improved plasma resistance and excellent porosity and hardness.

In addition, Korean Patent Application Publication No. 10-2005-0013968 (2005 Feb. 5) discloses a plasma-resistant member containing 100 ppm to 1000 ppm of a silicon element in an yttria coating layer. The yttria coating layer has electrical properties due to containing the silicon element as a semiconductor element, so the risk of arcing exists. Furthermore, the yttria coating layer is black, which is indistinguishable from that of semiconductor process contaminants, so there is a possibility that an unnecessary cleaning process is required due to confusion during chamber cleaning.

As described above, in order to overcome physical property limitations of yttria or yttrium fluoride thermal spray materials, techniques for producing yttrium oxyfluoride thermal spraying materials that have improved physical properties such as plasma erosion resistance, porosity, and hardness by mixing yttria and yttrium fluoride have been proposed. However, there is still a continuous demand for a technology for producing a dense thermal spray coating for improving plasma resistance and a granular powder for thermal spraying for use in producing the same from an industrial point of view.

The foregoing is intended merely to aid in the understanding of the background of the present disclosure, and is not intended to mean that the present disclosure falls within the purview of the related art that is already known to those skilled in the art.

### Documents of Related Art

(Patent document 1) Korean Patent Application Publication No. 10-2016-0131918 (2016 Nov. 16)
(Patent document 2) Korean Patent Application Publication No. 10-2005-0013968 (2005 Feb. 5)

### SUMMARY OF THE INVENTION

Accordingly, the present disclosure has been made keeping in mind the above problems occurring in the related art, and an objective of the present disclosure is to provide a method of producing an yttrium-based thermal spray coating using an yttrium-based granular powder including a silica powder. The inclusion of the silica powder lowers the melting point of an yttrium-based compound, thereby suppressing the formation of pores in a thermal spray coating during the production of the thermal spray coating. Due to the fact that the boiling point of silica is lower than the boiling point of the yttrium-based compound, the silica partially disappears during the production of the thermal spray coating, resulting in the formation of a dense yttrium-based thermal spray coating.

In order to achieve the above objective, according to one aspect of the present disclosure, there is provided a method of producing an yttrium-based thermal spray coating, the method including forming a coating on a substrate by atmospheric plasma spraying of an yttrium-based granular powder including at least one yttrium compound powder selected from the group consisting of Y₂O₃, YOF, YF₃, Y₄Al₂O₉, Y₃Al₅O₁₂, and YAlO₃, and a silica (SiO₂) powder, wherein the yttrium-based granular powder may include greater than 0 wt % and less than 10 w % of a Y—Si—O mesophase, and the coating may have a thickness of 100 μm to 250 μm.

In a preferred embodiment of the present disclosure, the atmospheric plasma spraying may be performed using a plasma gas including an inert gas having a flow rate of 40 NLPM to 60 NLPM.

In a preferred embodiment of the present disclosure, the atmospheric plasma spraying may be performed under a condition in which a plasma generation current intensity is 500 A to 700 A.

In a preferred embodiment of the present disclosure, the atmospheric plasma spraying may be performed under a condition in which a spray unit is disposed at a distance of 120 mm to 230 mm relative to the substrate, and a feed rate of a feeder is 10 to 30 g/min.

In a preferred embodiment of the present disclosure, the silicon element may be partially vaporized during production of the thermal spray coating.

In a preferred embodiment of the present disclosure, the yttrium-based granular powder may be prepared by mixing the yttrium compound powder having a mean grain diameter of 0.1 μm to 10 μm and accounting for 90 mass % to 99.9 mass % and the silica powder having a mean grain diameter of 0.1 μm to 10 μm and accounting for 0.1 mass % to 10 mass %.

According to another aspect of the present disclosure, there is provided an yttrium-based thermal spray coating produced by the method.

In a preferred embodiment of the present disclosure, a weight ratio of the silicon element to the yttrium element (Si/Y) may be 0.3 to 1.00.

In a preferred embodiment of the present disclosure, the yttrium compound may be yttria (Y₂O₃), and the yttria may include 70% to 90% of a monoclinic crystal structure.

In a preferred embodiment of the present disclosure, the yttrium-based thermal spray coating may have a porosity of less than 2%.

In a preferred embodiment of the present disclosure, the yttrium-based thermal spray coating may include greater than 0 wt % and less than 10 wt % of a Y—Si—O mesophase.

According to the present disclosure, the thermal spray coating produced from the yttrium-based granular powder including the silica constituent has a significantly high density, which enables a low etching rate at which the coating is etched by process gas during etching. Therefore, the coating can exhibit excellent durability when used as a coating material for members in a semiconductor chamber, and can be suppressed from undergoing peeling off caused by an etching phenomenon.

### BRIEF DESCRIPTION OF THE DRAWINGS

The above and other objectives, features, and other advantages of the present disclosure will be more clearly understood from the following detailed description when taken in conjunction with the accompanying drawings, in which:

FIGS. 1A, 1B, 1C, and 1D are side scanning electron microscope (SEM) images, respectively, of thermal spray coatings according to Examples 1 to 4 of the present disclosure; and

FIGS. 2A, 2B, 2C, and 2D are views illustrating results of X-ray diffraction analysis (XRD) of the thermal spray coatings according to Examples 1 to 4 of the present disclosure.

### DETAILED DESCRIPTION OF THE INVENTION

Unless otherwise defined, all terms including technical and scientific terms used herein have the same meaning as commonly understood by one of ordinary skill in the art to which this disclosure belongs. Generally, nomenclature used in the present specification is well known and commonly used in the art.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

In a semiconductor fabricating process, a gate etching device, an insulating film etching device, a resist film etching device, a sputtering device, a chemical vapor deposition (CVD) device, etc. are used. On the other hand, in a liquid crystal fabricating process, an etching device, etc. for forming a thin film transistor is used. Moreover, these devices have a configuration including a plasma generator for the purpose of high integration through microfabrication.

As a process gas in such fabricating processes, a halogen-based corrosive gas such as fluorine-based gas, chlorine-based gas, etc. is used for the above-described devices due to high reactivity thereof. Examples of the fluorine-based gas include SF₆, CF₄, CHF₃, ClF₃, HF, NF₃, etc., and examples of the chlorine-based gas include Cl₂, BCl₃, HCl, CCl₄, SiCl₄, etc. When microwaves, high frequency, or the like are introduced into an atmosphere into which these gases are introduced, these gases are converted into plasma. A device member exposed to these halogen-based gas or plasma thereof are required to have a very small content of metals other than material components on the surface thereof and to have high corrosion resistance.

Therefore, an aspect of the present disclosure pertains to a highly plasma-resistant thermal spray coating for application to a member for a plasma etching device.

A method of producing an yttrium-based thermal spray coating according to the present disclosure includes the step of forming a coating on a substrate by atmospheric plasma spraying of an yttrium-based granular powder including at least one yttrium compound powder selected from the group consisting of Y₂O₃, YOF, YF₃, Y₄Al₂O₉, Y₃Al₅O₁₂, and YAlO₃, and a silica (SiO₂) powder. The yttrium-based granular powder includes less than 10 w % of a Y—Si—O mesophase.

As a thermal spray material for atmospheric plasma spraying employed as the thermal spraying process for producing the thermal spraying coating according to the present disclosure, granular powder, which is composed of granular secondary particles formed by agglomeration of primary particles of several μm, is used. In view of this, a method of increasing the density of a thermal spray coating by configuring primary particles constituting a thermal spray material as small as equal to or less than 1 μm has been proposed. However, the increase in specific surface area of the thermal spray material hinders uniform heat transfer to the primary particles inside granular powder, with the result that a coating in an unmelted or re-melted state is formed on the surface or inside of the thermal spray coating and acts as a cause of particle generation during dry etching.

Therefore, the method of producing the yttrium-based thermal spray coating according to the present disclosure features the use of the yttrium-based granular powder including, as constituents thereof, any one or at least two selected from the group consisting of Y₂O₃, YOF, YF₃, Y₄Al₂O₉, Y₃Al₅O₁₂, and YAlO₃ and silica (SiO₂) in addition to an yttrium-based compound so as to reduce the melting point of the yttrium-based compound. This lowers the melting point of the yttrium-based compound, thereby enabling the molten yttrium-based granular powder reaching the substrate to form a dense thermal spray coating with low porosity. Another feature is that a part of silica disappears during the thermal spraying process.

The atmospheric plasma spraying process involves the use of a plasma flame generated in a plasma gun. A coating material is introduced into the plasma flame to be melted. The melted material is deposited onto the substrate after having been heated and accelerated by the plasma flame. For example, the plasma flame may be produced by partial ionization of a plasma gas including argon gas (Ar), nitrogen gas (N₂), hydrogen gas (H₂), helium gas (He), etc.

The atmospheric plasma spraying process is performed under the following process parameters. Preferably, the flow rate of inert gas is 40 NLPM to 60 NLPM, the flow rate of hydrogen gas is 5 NLPM to 15 NLPM. More preferably, the flow rate of inert gas is 45 NLPM to 50 NLPM, and the flow rate of hydrogen gas is 7 NLPM to 10 NLPM.

When the flow rate of introduced inert gas is less than 40 NLPM, the total heat capacity is lowered due to low plasma output, resulting in a decrease in the porosity and deposition rate of the thermal spray coating. On the other hand, when the flow rate of introduced inert gas exceeds 60 NLPM, plasma output becomes too high, causing etching of consumables.

When the flow rate of introduced hydrogen gas is less than 5 NLPM, plasma output becomes too low to ignite. On the other hand, when the flow rate of introduced hydrogen gas is greater than 15 NLPM, turbulence of the plasma gas becomes more severe and the interaction of the turbulence with the surrounding air increases.

Furthermore, the atmospheric plasma spraying process is performed under a condition in which the plasma generation current intensity is preferably 500 A to 700 A, more preferably 570 A to 630 A.

The atmospheric plasma spraying process is performed under a condition in which a spray unit is preferably disposed at a distance of 120 mm to 230 mm relative to the substrate, and more preferably at a distance of 130 mm to 170 mm.

When the distance between the spray unit and the surface of the substrate is closer than about 120 mm, the working distance becomes too short, making it difficult to produce a uniform thermal spray coating. On the other hand, when the distance therebetween is farther than 230 mm, the flight distance of the yttrium-based granular powder becomes longer. As a result of solidification of the molten granular powder that has reached the substrate, a coating with low density is formed due to the presence of pores.

In this case, when the distance between the spray unit and the surface of the substrate is 120 mm to 230 mm, the feed rate of a feeder transported by the spray unit is preferably 10 g/min to 30 g/min. When the feed rate of the feeder exceeds 30 g/min and the feed amount of feed powder transported for a unit time is too large, it is difficult to produce a uniform thermal spray coating, and the porosity of the thermal spray coating increases due to incomplete melting of the feed powder. On the other hand, when the feed rate of the feeder is less than 10 g/min, an insufficient feed amount causes a pulsation of the thermal spray coating, resulting in a decrease in the uniformity of the thermal spray coating and a decrease in production yield.

In the atmospheric plasma spraying process, the yttrium-based spray coating preferably has a thickness of 100 μm to 250 μm.

In this case, the yttrium-based granular powder may be prepared by mixing an yttrium compound powder having a mean grain diameter of 0.1 μm to 10 μm and accounting for 90 mass % to 99.9 mass % and a silica powder having a mean grain diameter of 0.1 μm to 10 μm and accounting for 0.1 mass % to 10 mass %.

In the yttrium-based granular powder for thermal spraying, preferably, the yttrium compound is included in a content of 90 mass % to 99.9 mass %, and the silica is included in a content of 0.1 mass % to 10 mass %. More preferably, the yttrium compound is included in a content of 95 mass % to 99.5 mass %, and the silica is included in a content of 0.5 mass % to 5 mass %.

When the content of the silica is less than 0.1 mass %, the effect of lowering the melting point of the silica during the production of the thermal spray coating is insignificant. On the other hand, when the content thereof exceeds 10 mass %, the constituent to be disappeared in the form of silica (SiO₂) is converted into a Y—Si—O mesophase, remaining in excess in the thermal spray coating.

Due to the fact that the boiling point of the silica is lower than the melting point of the yttrium compound, as the silica is partially or totally vaporized while the granular powder is liquefied and scattered during the production of the thermal spray coating according to the present disclosure, which provides an effect of lowering the melting point of the yttrium-based granular powder for thermal spraying. As a result, the content of the silica remaining in the thermal spray coating is reduced compared to before being fed to the process of producing the thermal spray coating.

The yttrium compound powder selected from the group consisting of Y₂O₃, YOF, YF₃, Y₄Al₂O₉, Y₃Al₅O₁₂, and YAlO₃ and the silica powder preferably each has a mean grain diameter of 0.1 μm to 10 μm, and more preferably 0.2 μm to 5 μm.

When the mean grain diameter of the yttrium compound powder and the silica powder is less than about 0.1 μm, a Y—Si—O mesophase may be generated, and it may be difficult to form a spherical granular powder and control the physical properties thereof due to the difficulty in controlling the powders. On the other hand, when the mean grain diameter of the yttrium compound powder and the silica powder as primary particles exceeds about 10 μm, the mean grain diameter of the granular powder formed by agglomeration of the primary particles becomes too large, making it difficult to form a uniform thermal spray coating.

The difference in the mean grain diameter between the silica powder and the yttrium compound powder is preferably equal to or less than 30%. When the mean grain diameter of the silica powder is at least 30% greater than that of the yttrium compound powder, an excess amount of Y—Si—O mesophase may be generated during coating formation.

The mean grain diameter of the yttrium-based granular powder for thermal spraying according to the present disclosure may be 5 μm to 50 μm, preferably 10 μm to 40 μm, and more preferably 15 μm to 30 μm.

When the mean grain diameter of the yttrium-based granular powder for thermal spraying is less than 5 μm, during thermal spraying, the granular powder has low fluidity, making it difficult to implement a uniform coating. In addition, the granular powder is oxidized before being transported to a frame or fails to be transported to the center of the frame, so it is difficult to satisfy sufficient droplet flying speed and heat quantity to form a dense coating, resulting in a coating with high porosity or low hardness. When the mean grain diameter of the yttrium-based granular powder for thermal spraying exceeds 50 μm, the granular powder is not completely melted due to reduced melt specific surface area thereof, generating an unmelted portion in the coating, which makes it difficult to satisfy thermal spray coating quality required by the present disclosure.

The aspect ratio of the yttrium-based granular powder for thermal spraying according to the present disclosure is expressed as the ratio of the long diameter to the short diameter thereof. The aspect ratio is equal to or greater than 1.0 and equal to or less than 5.0, which is preferable from the viewpoint of forming a dense and uniform coating. From this viewpoint, the aspect ratio is more preferably equal to or greater than 1.0 and equal to or less than 4.0, and particularly preferably equal to or greater than 1.0 and equal to or less than 1.5.

As far as the yttrium-based granular powder for thermal spraying is concerned, fluidity is an important factor that determines the quality of the thermal spray coating. Therefore, it is most preferable that the granular powder has a spherical shape.

Otherwise, during the production of the thermal spray coating, a given amount of powder may not be transported to the frame, making it difficult to implement a coating which satisfies requirements of the present disclosure.

As an example, the silicon element may be partially vaporized during the production of the thermal spray coating, and the weight ratio of the silicon element to the yttrium element (Si/Y) in the yttrium-based granular powder for thermal spraying may be 0.3 to 1.00.

The yttrium-based granular powder may be produced by the steps of: (a) preparing a mixture by mixing at least one yttrium compound powder selected from the group consisting of Y₂O₃, YOF, YF₃, Y₄Al₂O₉, Y₃Al₅O₁₂, and YAlO₃, and a silica (SiO₂) powder; (b) preparing a granular powder by granulating the mixture; and (c) sintering the granular powder at 1200° C. to 1450° C. to obtain an yttrium-based granular powder.

Since at least one yttrium compound powder selected from the group consisting of Y₂O₃, YOF, YF₃, Y₄Al₂O₉, Y₃Al₅O₁₂, and YAlO₃ and the silica (SiO₂) powder, which are primary particles, have a fluidity that does not reach the level required for thermal spraying, it is preferable to configure a spherical granular powder through mixing, granulation, and sintering.

In step (a), the at least one yttrium compound powder selected from the group consisting of Y₂O₃, YOF, YF₃, Y₄Al₂O₉, Y₃Al₅O₁₂, and YAlO₃ and the silica (SiO₂) powder are mixed with a sintering aid and a dispersion medium to obtain a mixture. If necessary, slurry droplets may be prepared by further adding a binder to the mixture.

The binder is preferably an organic compound. Examples of the organic compound include, but are not limited to, an organic compound consisting of carbon, hydrogen and oxygen, or carbon, hydrogen, oxygen and nitrogen, such as carboxymethylcellulose (CMC), polyvinyl alcohol (PVA), polyvinylpyrrolidone (PVP), etc.

Thereafter, in step (b), the mixture including the yttrium compound powder and the silica (SiO₂) powder is subjected to a granulation process to obtain the granular powder. As a granulation device, e.g., a spray-drying device may be used. In the spray drying device, slurry droplets including a plurality of powder particles are dropped through the hot air. As a result of solidification of the droplets, intermediate granules made up of agglomerated particles are formed.

Finally, in step (c), the granular powder is subjected to a sintering process. The sintering temperature is preferably 1200° C. to 1450° C. With the sintering in this temperature range, the yttrium compound powder and the silica (SiO₂) powder in the granular powder are physically combined.

The sintering time is preferably equal to or greater than two hours and equal to or less than eight hours under the condition in which the sintering temperature is within the above range. The sintering atmosphere may be an oxygen-containing atmosphere such as an atmospheric atmosphere, but preferably is an inert gas atmosphere such as argon gas or a vacuum atmosphere.

In the present disclosure, the substrate coated with the thermal spray coating is particularly limited. For example, the material or shape of the substrate is not particularly limited, as long as it is a substrate that includes a material capable of exhibiting desired resistance. The material constituting the substrate is preferably selected from a combination of at least one of aluminum, nickel, chromium, zinc and alloys thereof constituting a member for semiconductor fabricating equipment, etc., alumina, aluminum nitride, silicon nitride, silicon carbide, and quartz glass.

The substrate is, e.g., a member constituting semiconductor device fabricating equipment, and may be a member exposed to a highly reactive oxygen gas plasma or halogen gas plasma.

The surface of the substrate is preferably processed based on the ceramic thermal spraying operation standard prescribed in JIS H 9302 before plasma spraying. For example, after removing rust and oils from the surface of the substrate, the surface is roughened by spraying abrasive particles such as Al₂O₃ and SiC, and then pre-treated into a state in which the thermal spray powder particles tend to adhere.

A conventional yttrium-based thermal spray coating has high porosity. However, the present disclosure employs the use of a silica constituent as primary particles to lower the melting point of the yttrium-based compound, thereby suppressing the formation of pores in the thermal spray coating during the production of the thermal spray coating. As the silica constituent naturally disappears during a high-temperature process for the production of the coating, a dense yttrium-based thermal spray coating with low porosity is obtained.

Therefore, the yttrium-based thermal spray coating according to the present disclosure has a superior porosity level compared to the conventional thermal spray coating. As a result, when applied to a semiconductor chamber used in an etching process, the yttrium-based thermal spray coating exhibits excellent durability and is suppressed from undergoing the phenomenon in which the coating peels off by etching gas.

In this case, the silicon element may be partially vaporized during the production of the thermal spray coating, and thus the weight ratio of the silicon element to the yttrium element (Si/Y) may be 0.3 to 1.00.

In the yttrium-based thermal spray coating according to the present disclosure, when the yttrium compound is yttria (Y₂O₃), the yttria may include 70% to 90% of a monoclinic crystal structure. In this case, it is interpreted that the monoclinic crystal phase of the yttria (Y₂O₃) provides an effect of increasing bonding strength between yttria powders, thereby contributing to the formation of fine pores in the thermal spray coating.

As an example, the yttrium-based thermal spray coating formed by the method of producing the yttrium-based thermal spray coating according to the present disclosure may have a porosity of less than 2%, preferably less than 1.5%, and more preferably less than 1%.

It is preferable that the yttrium-based thermal spray coating according to the present disclosure does not include a Y—Si—O mesophase, or includes less than 10 wt % of at least one Y—Si—O mesophase.

Hereinafter, the present disclosure will be described in more detail through examples. However, the following examples are merely illustrative of the present disclosure, and the present disclosure is not limited thereby.

Preparation Examples 1 to 2

In each Preparation Example, an yttria granular powder having a mixing ratio of yttrium to oxygen of 78/22 was used.

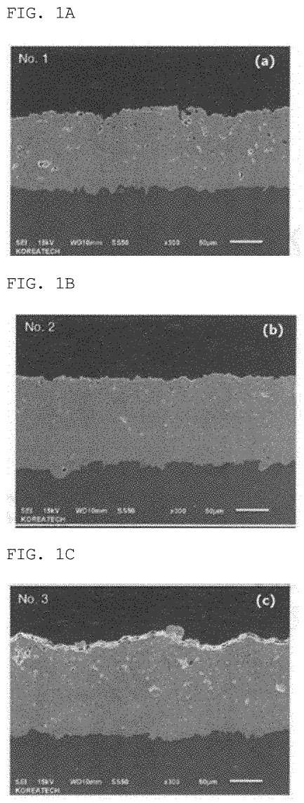

After mixing a binder with an yttria powder and a silica powder, the resulting mixture was granulated by a spray dryer to obtain a granular powder. The granular powder was then degreased and sintered to obtain a final yttria granular powder. Experimental conditions such as the size and mixing ratio of the yttria powder and the silica powder used in each Preparation Example are illustrated in Table 1 below, and scanning electron microscope (SEM) images of prepared granular powders are illustrated in FIGS. 1A, 1B, 1C, and 1D.

TABLE 1

| | | Grain | Mixing ratio | Mixing ratio |
|---|---|---|---|---|
| | | size | of primary | in granular |
| | Constituent | (μm) | particles (wt %) | powder (wt %) |
| Preparation | Y₂O₃ | 8.2 | 99.0 | Y: 65.93 |
| Example 1 | SiO₂ | 0.8 | 1.0 | Si: 1.45 |
| | | | | O: 32.62 |
| Preparation | Y₂O₃ | 0.7 | 99.0 | Y: 68.20 |
| Example 2 | SiO₂ | 0.8 | 1.0 | Si: 1.21 |
| | | | | O: 30.58 |
| Preparation | Y₂O₃ | 0.7 | 95.0 | Y: 70.02 |
| Example 3 | SiO₂ | 0.8 | 5.0 | Si: 5.35 |
| | | | | O: 24.63 |
| Preparation | Y₂O₃ | 0.7 | 90.0 | Y: 73.07 |
| Example 4 | SiO₂ | 0.8 | 10.0 | Si: 2.94 |
| | | | | O: 23.99 |
| Preparation | Y₂O₃ | 0.7 | 65.0 | Y: 55.54 |
| Example 5 | SiO₂ | 0.8 | 35.0 | Si: 12.41 |
| | | | | O: 32.06 |
| Preparation | Y₂O₃ | 0.7 | 50.0 | Y: 41.00 |
| Example 6 | SiO₂ | 0.8 | 50.0 | Si: 19.70 |
| | | | | O: 39.29 |

### Examples 1 to 8

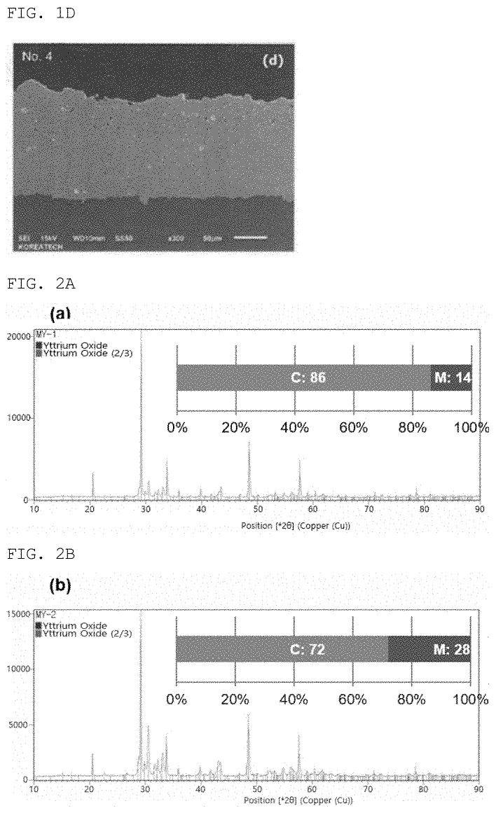

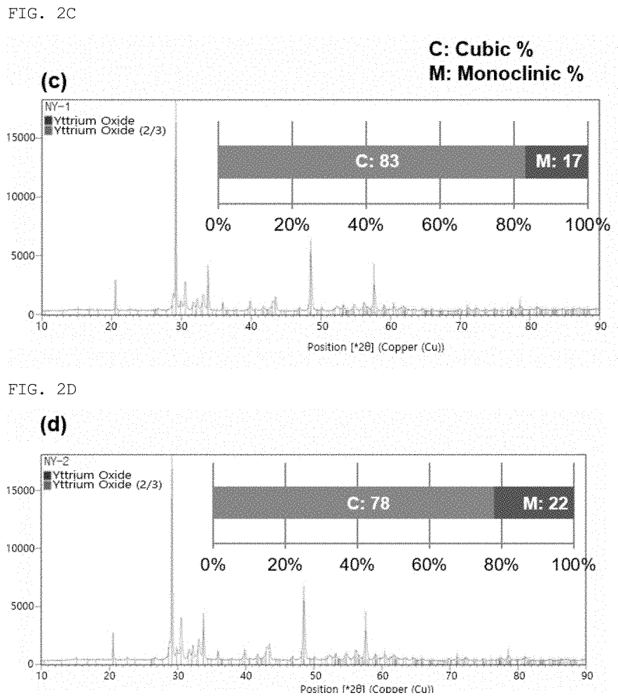

Thermal spray materials prepared in Preparation Examples 1 and 4 and a plasma gun were used to produce thermal spray coatings. The plasma gun generated a plasma flame at 40 kW to 50 kW in the flow of argon and hydrogen gases as heat source gases. Each feed powder was heated and melted by the plasma flame to form a coating on a substrate. The coating was formed to a thickness of 150 μm to 200 μm, and experimental conditions are illustrated in Table 2 below. Side scanning electron microscope (SEM4) images of the produced thermal spray coatings are illustrated in FIGS. 2A, 2B, 2C and 2D.

TABLE 2

| | | Plasma | | Feeder | |
|---|---|---|---|---|---|
| | | conditions | | conditions | |
| | | | Current | Feed | Dis- |
| Classifi- | | Ar | intensity | rate(g/ | tance |
| cation | Material | (NLPM) | (A) | min) | (mm) |
| Example 1 | Preparation | 48 | 600 | 20 | 200 |
| | Example 1 | | | | |
| Example 2 | Preparation | 48 | 600 | 20 | 150 |
| | Example 1 | | | | |
| Example 3 | Preparation | 48 | 600 | 20 | 200 |
| | Example 2 | | | | |
| Example 4 | Preparation | 48 | 600 | 20 | 150 |
| | Example 2 | | | | |
| Example 5 | Preparation | 48 | 600 | 20 | 200 |
| | Example 3 | | | | |
| Example 6 | Preparation | 48 | 600 | 20 | 150 |
| | Example 3 | | | | |
| Example 7 | Preparation | 48 | 600 | 20 | 200 |
| | Example 4 | | | | |
| Example 8 | Preparation | 48 | 600 | 20 | 150 |
| | Example 4 | | | | |

Comparative Examples 1 to 6

In Comparative Examples 1 and 2, the size of primary particles in an yttria granular powder was 5 μm, the size of the yttria granular powder was 35 μm, and the mixing ratio of yttrium to oxygen in the yttria granular powder was 78/22.

The procedure was performed in the same manner as in Examples using the yttria granular powder and thermal spray materials prepared in Preparation Examples 5 and 6 to obtain thermal spray coatings, and experimental conditions are illustrated in Table 3 below.

TABLE 3

| | | Plasma | | Feeder | |
|---|---|---|---|---|---|
| | | conditions | | conditions | |
| | | | Current | Feed | Dis- |
| Classifi- | | Ar | intensity | rate(g/ | tance |
| cation | Material | (NLPM) | (A) | min) | (mm) |
| Comparative | Y₂O₃ | 48 | 600 | 20 | 200 |
| Example 1 | | | | | |
| Comparative | Y₂O₃ | 48 | 600 | 20 | 150 |
| Example 2 | | | | | |
| Comparative | Preparation | 48 | 600 | 20 | 200 |
| Example 3 | Example 5 | | | | |
| Comparative | Preparation | 48 | 600 | 20 | 150 |
| Example 4 | Example 5 | | | | |
| Comparative | Preparation | 48 | 600 | 20 | 200 |
| Example 5 | Example 6 | | | | |
| Comparative | Preparation | 48 | 600 | 20 | 150 |
| Example 6 | Example 6 | | | | |

Experimental Example 1: Observation of Thermal Spray Coating

FIGS. 2A, 2B, 2C, and 2D are side scanning electron microscope (SEM) images, respectively, of thermal spray coatings according to Examples 1 to 4 according to the present disclosure. Through the side scanning electron microscope (SEM) images illustrated in FIGS. 2A, 2B, 2C, and 2D, it was confirmed that dense thermal spray coatings with low porosity were obtained according to the present disclosure.

The measurement of porosity was performed as follows. Each of the thermal spray coatings was cut along a plane orthogonal to the substrate surface. The resulting cross-section was resin-filled and polished, and then an image of the cross-section was taken with an electron microscope (JS-6010 available from JEOL) (FIGS. 2A, 2B, 2C, and 2D). The image was analyzed by image analysis software (Image Pro available from MEDIA CYBERNETICS) to identify pore areas in the cross-section image. The ratio of the pore areas to the entire cross-section was calculated to determine the porosity, and the results are illustrated in Table 4 below.

The thermal spray coatings produced in Comparative Examples 1 and 2 exhibited a porosity of equal to or greater than 2%, whereas the thermal spray coatings produced in Examples 1 to 4 all exhibited a porosity of less than 1.5%. This indicates that the density of the yttrium-based thermal spray coating according to the present disclosure was increased compared to the conventional thermal spray coating.

As illustrated in FIGS. 2A, 2B, 2C, and 2D as a result of X-ray diffraction analysis (XRD) analysis with a scanning electron microscope (SEM), it was confirmed that the thermal spray coatings according to Examples 1 to 4 had a monoclinic crystal structure at a higher ratio than that of a cubic structure. It has been reported that yttria is effective in increasing bonding strength between primary particles due to the presence of such a monoclinic crystal structure, and it is believed that the porosity was reduced due to the crystal structure of yttria.

TABLE 4

| | Constituent ratio of | | | Measurement Data | | | |
|---|---|---|---|---|---|---|---|
| | thermal spray coating | | | Porosity | Hardness | Roughness | Deposition rate |
| Classification | Y | Si | O | (%) | (Hv) | (Ra, μms) | (μm/pass) |
| Example 1 | 78.35 | 0.55 | 21.10 | <1.5 | 400~450 | 4.6~5.3 | >10 |
| Example 2 | 78.51 | 0.62 | 20.87 | <1.0 | 400~450 | 3.2~3.9 | >9 |
| Example 3 | 77.37 | 0.53 | 22.09 | <1.0 | 400~450 | 4,7~5.5 | >10 |
| Example 4 | 77.91 | 0.55 | 21.51 | <1.0 | 450~500 | 3.1~3.7 | >10 |
| Example 5 | 76.35 | 1.22 | 22.43 | <1.0 | 400~450 | 3.8~4.1 | 8.9 |
| Example 6 | 75.42 | 1.32 | 23.26 | <1.0 | 400~450 | 3.3~3.7 | 6.6 |
| Example 7 | 72.41 | 2.97 | 24.62 | <1.5 | 400~450 | 3.6~4.0 | 9.2 |
| Example 8 | 73.44 | 3.12 | 23.44 | <1.5 | 400~450 | 3.2~4.0 | 6.7 |
| Comparative | 54.72 | 13.32 | 31.96 | <2.5 | 350~400 | 3.7~4.3 | 8.9 |
| Example 3 | | | | | | | |
| Comparative | 53.61 | 12.80 | 33.59 | <2.5 | 350~400 | 4.7~4.9 | 6.3 |
| Example 4 | | | | | | | |
| Comparative | 39.86 | 20.08 | 40.06 | <3.5 | 300~350 | 4.8~5.5 | 10.6 |
| Example 5 | | | | | | | |
| Comparative | 39.63 | 19.47 | 40.90 | <3.5 | 300~350 | 4.6~5.3 | 8.3 |
| Example 6 | | | | | | | |
| Comparative | | | | 3.5~5.0 | 400~450 | 3.5~5.5 | 2.5~3.5 |
| Example 1 | | | | | | | |
| Comparative | | | | 2.0~2.5 | 500~550 | 5~7 | 5~6 |
| Example 2 | | | | | | | |

Experimental Example 2: Measurement of Hardness

In Table 4 above, the column headed “Hardness” shows the measurement result of the Vickers hardness of each thermal spray coating. The Vickers hardness (HV 0.2) was determined using a micro hardness tester with a test load of 294.2 mN applied by a diamond indenter having an apical angle of 136°.

As illustrated in Table 4 above, it was confirmed that the thermal spray coatings produced in Examples 1 to 4 exhibited hardness similar to that of the thermal spray coatings produced in Comparative Examples 1 and 2.

Experimental Example 3: Measurement of Roughness

The roughness (μm) of each of the coatings produced in Example and Comparative Examples of the present disclosure was measured with a roughness tester (SJ-201), and the results are illustrated in Table 4 above.

Experimental Example 4: Measurement of Deposition Rate

The thickness of each of the coatings produced in Examples and Comparative Examples of the present disclosure was observed on a cross-sectional SEM image, and a value obtained by dividing the thickness by the number of times a corresponding coating process was performed is illustrated in Table 4 above.

While the exemplary embodiments of the disclosure have been described above, the embodiments are only examples of the disclosure, and it will be understood by those skilled in the art that the disclosure can be modified in various forms without departing from the technical spirit of the disclosure. Therefore, the scope of the disclosure should be determined on the basis of the descriptions in the appended claims, not any specific embodiment, and all equivalents thereof should belong to the scope of the disclosure.

1. A method of producing an yttrium-based thermal spray coating, the method comprising
forming a coating on a substrate by atmospheric plasma spraying of an yttrium-based granular powder comprising at least one yttrium compound powder selected from the group consisting of Y₂O₃, YOF, YF₃, Y₄Al₂O₉, Y₃Al₅O₁₂, and YAlO₃, and a silica (SiO₂) powder,
wherein the yttrium-based granular powder comprises greater than 0 wt % and less than 10 w % of a Y—Si—O mesophase, and
the coating has a thickness of 100 μm to 250 μm.

2. The method of claim 1, wherein the atmospheric plasma spraying is performed using a plasma gas comprising an inert gas having a flow rate of 40 NLPM to 60 NLPM.

3. The method of claim 1, wherein the atmospheric plasma spraying is performed under a condition in which a plasma generation current intensity is 500 A to 700 A.

4. The method of claim 1, wherein the atmospheric plasma spraying is performed under a condition in which a spray unit is disposed at a distance of 120 mm to 230 mm relative to the substrate, and a feed rate of a feeder is 10 to 30 g/min.

5. The method of claim 1, wherein the silicon element is partially vaporized during production of the thermal spray coating.

6. The method of claim 1, wherein the yttrium-based granular powder is prepared by mixing the yttrium compound powder having a mean grain diameter of 0.1 μm to 10 μm and accounting for 90 mass % to 99.9 mass % and the silica powder having a mean grain diameter of 0.1 μm to 10 μm and accounting for 0.1 mass % to 10 mass %.

7. An yttrium-based thermal spray coating produced by the method of claim 1.

8. The yttrium-based thermal spray coating of claim 7, wherein a weight ratio of the silicon element to the yttrium element (Si/Y) is 0.3 to 1.00.

9. The yttrium-based thermal spray coating of claim 7, wherein the yttrium compound is yttria (Y₂O₃), and
the yttria comprises 70% to 90% of a monoclinic crystal structure.

10. The yttrium-based thermal spray coating of claim 7, wherein the yttrium-based thermal spray coating has a porosity of less than 2%.

11. The yttrium-based thermal spray coating of claim 7, wherein the yttrium-based thermal spray coating comprises greater than 0 wt % and less than 10 wt % of a Y—Si—O mesophase.
